(19) United States
(12) Patent Application Publication
(10) Pub. No.: US 2021/0303715 A1
(43) Pub. Date: Sep. 30, 2021

(54) DATA SCRAMBLER FOR MEMORY SYSTEMS AND METHOD THEREOF

(71) Applicant: SK hynix Inc., Gyeonggi-do (KR)

(72) Inventors: Siarhei ZALIVAKA, Minsk (BY); Alexander IVANIUK, Minsk (BY)

(21) Appl. No.: 16/829,183

(22) Filed: Mar. 25, 2020

(51) Int. Cl. G06F 21/62

(52) U.S. Cl. CPC G06F 21/6218

(57) ABSTRACT

A data scrambler scrambles data for a memory system. The scrambler performs an exclusive OR (XOR) operation on data with a pseudorandom number to generate first scrambled data; identifies a state corresponding to the first scrambled data, among multiple states in a set threshold voltage distribution; transitions the first scrambled data from the identified state to another state in response to a program and erase (PE) counter value; and generates second scrambled data using a subset of encoding values corresponding to the another state, among set encoding values for the multiple states.

### BACKGROUND

### 1. Field

Embodiments of the present disclosure relate to a data scrambler for memory systems.

### 2. Description of the Related Art

The computer environment paradigm has shifted to ubiquitous computing systems that can be used anytime and anywhere. As a result, the use of portable electronic devices such as mobile phones, digital cameras, and notebook computers has rapidly increased. These portable electronic devices generally use a memory system having memory device(s), that is, data storage device(s). The data storage device is used as a main memory device or an auxiliary memory device of the portable electronic devices.

Memory systems using memory devices provide excellent stability, durability, high information access speed, and low power consumption, since they have no moving parts. Examples of memory systems having such advantages include universal serial bus (USB) memory devices, memory cards having various interfaces such as a universal flash storage (UFS), and solid state drives (SSDs). Memory systems such as NAND flash based memory systems may include a data scrambler (or a randomizer) for uniformly programming data to memory devices.

### SUMMARY

Aspects of the present invention include a data scrambler for scrambling data for a memory system and a method thereof.

In one aspect, a memory system includes a memory device including a plurality of cells and a controller including a scrambler. The scrambler receives data having multiple bits; performs an exclusive OR (XOR) operation on the data with a pseudorandom number to generate first scrambled data, the pseudorandom number being generated in response to a seed value based on a logical block address (LBA) or a physical page number (PPN); identifies a state corresponding to the first scrambled data, among multiple states in a set threshold voltage distribution; transitions the first scrambled data from the identified state to another state of the multiple states, in response to a program and erase (PE) counter value; and generates second scrambled data for storage in a target cell among the plurality of cells, using a subset of encoding values corresponding to the another state, among set encoding values for the multiple states.

In another aspect, a method for operating a memory system, which includes a memory device including a plurality of cells and a controller including a scrambler. The method of the scrambler includes: receiving data having multiple bits; performing an exclusive OR (XOR) operation on the data with a pseudorandom number to generate first scrambled data, the pseudorandom number being generated in response to a seed value based on a logical block address (LBA) or a physical page number (PPN); identifying a state corresponding to the first scrambled data, among multiple states in a set threshold voltage distribution; transitioning the first scrambled data from the identified state to another state of the multiple states, in response to a program and erase (PE) counter value; and generating second scrambled data for storage in a target cell among the plurality of cells, using a subset of encoding values corresponding to the another state, among set encoding values for the multiple states.

Additional aspects of the present invention will become apparent from the following description.

### BRIEF DESCRIPTION OF THE DRAWINGS

FIG. 1 is a block diagram illustrating a data processing system in accordance with an embodiment of the present invention.

FIG. 2 is a block diagram illustrating a memory system in accordance with an embodiment of the present invention.

FIG. 3 is a circuit diagram illustrating a memory block of a memory device in accordance with an embodiment of the present invention.

FIG. 4 is a diagram illustrating distributions of states for different types of cells of a memory device.

FIG. 5 is a diagram illustrating a memory system in accordance with an embodiment of the present invention.

FIG. 6 illustrates a standard scrambler.

FIG. 7 is a diagram illustrating a scrambler in accordance with embodiments of the present invention.

FIG. 8A illustrates distribution of threshold voltages for a memory cell of TLC NAND flash memory device.

FIG. 8B illustrates an example of an encoding scheme for TLCs.

FIGS. 9A and 9B illustrate examples of state transition in accordance with an embodiment of the present invention.

FIG. 10 is a flowchart illustrating an operation of a scrambler in accordance with an embodiment of the present invention.

FIG. 11A illustrates threshold voltage distribution for all PV regions and FIG. 11B illustrates threshold voltage distribution for PV₀ region.

### DETAILED DESCRIPTION

Various embodiments are described below in more detail with reference to the accompanying drawings. The present invention may, however, be embodied in different forms and thus should not be construed as limited to the embodiments set forth herein. Rather, these embodiments are provided so that this disclosure is thorough and complete and fully conveys the scope of the present invention to those skilled in the art. Moreover, reference herein to “an embodiment,” “another embodiment,” or the like is not necessarily to only one embodiment, and different references to any such phrase are not necessarily to the same embodiment(s). Throughout the disclosure, like reference numerals refer to like parts in the figures and embodiments of the present invention.

The invention can be implemented in numerous ways, including as a process; an apparatus; a system; a computer program product embodied on a computer-readable storage medium; and/or a processor, such as a processor suitable for executing instructions stored on and/or provided by a memory coupled to the processor. In this specification, these implementations, or any other form that the invention may take, may be referred to as techniques. In general, the order of the steps of disclosed processes may be altered within the scope of the invention. Unless stated otherwise, a component such as a processor or a memory described as being suitable for performing a task may be implemented as a general component that is temporarily configured to perform the task at a given time or a specific component that is manufactured to perform the task. As used herein, the term ‘processor’ or the like refers to one or more devices, circuits, and/or processing cores suitable for processing data, such as computer program instructions.

A detailed description of embodiments of the invention is provided below along with accompanying figures that illustrate aspects of the invention. The invention is described in connection with such embodiments, but the invention is not limited to any embodiment. The scope of the invention is limited only by the claims. The invention encompasses numerous alternatives, modifications and equivalents within the scope of the claims. Numerous specific details are set forth in the following description in order to provide a thorough understanding of the invention. These details are provided for the purpose of example; the invention may be practiced according to the claims without some or all of these specific details. For clarity, technical material that is known in technical fields related to the invention has not been described in detail so that the invention is not unnecessarily obscured.

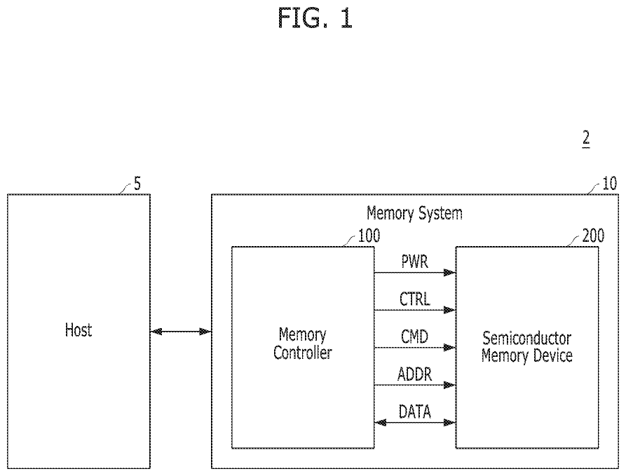

FIG. 1 is a block diagram illustrating a data processing system 2 in accordance with an embodiment of the present invention.

Referring FIG. 1, the data processing system 2 may include a host device 5 and a memory system 10. The memory system 10 may receive a request from the host device 5 and operate in response to the received request. For example, the memory system 10 may store data to be accessed by the host device 5.

The host device 5 may be implemented with any one of various kinds of electronic devices. In various embodiments, the host device 5 may include an electronic device such as a desktop computer, a workstation, a three-dimensional (3D) television, a smart television, a digital audio recorder, a digital audio player, a digital picture recorder, a digital picture player, and/or a digital video recorder and a digital video player. In various embodiments, the host device 5 may include a portable electronic device such as a mobile phone, a smart phone, an e-book, an MP3 player, a portable multimedia player (PMP), and/or a portable game player.

The memory system 10 may be implemented with any one of various kinds of storage devices such as a solid state drive (SSD) and a memory card. In various embodiments, the memory system 10 may be provided as one of various components in an electronic device such as a computer, an ultra-mobile personal computer (PC) (UMPC), a workstation, a net-book computer, a personal digital assistant (PDA), a portable computer, a web tablet PC, a wireless phone, a mobile phone, a smart phone, an e-book reader, a portable multimedia player (PMP), a portable game device, a navigation device, a black box, a digital camera, a digital multimedia broadcasting (DMB) player, a 3-dimensional television, a smart television, a digital audio recorder, a digital audio player, a digital picture recorder, a digital picture player, a digital video recorder, a digital video player, a storage device of a data center, a device capable of receiving and transmitting information in a wireless environment, a radio-frequency identification (RFID) device, as well as one of various electronic devices of a home network, one of various electronic devices of a computer network, one of electronic devices of a telematics network, or one of various components of a computing system.

The memory system 10 may include a memory controller 100 and a semiconductor memory device 200. The memory controller 100 may control overall operations of the semiconductor memory device 200.

The semiconductor memory device 200 may perform one or more erase, program, and read operations under the control of the memory controller 100. The semiconductor memory device 200 may receive a command CMD, an address ADDR and data DATA through input/output lines. The semiconductor memory device 200 may receive power PWR through a power line and a control signal CTRL through a control line. The control signal CTRL may include a command latch enable signal, an address latch enable signal, a chip enable signal, a write enable signal, a read enable signal, as well as other operational signals depending on design and configuration of the memory system 10.

The memory controller 100 and the semiconductor memory device 200 may be integrated in a single semiconductor device such as a solid state drive (SSD). The SSD may include a storage device for storing data therein. When the semiconductor memory system 10 is used in an SSD, operation speed of a host device (e.g., host device 5 of FIG. 1) coupled to the memory system 10 may remarkably improve.

The memory controller 100 and the semiconductor memory device 200 may be integrated in a single semiconductor device such as a memory card. For example, the memory controller 100 and the semiconductor memory device 200 may be so integrated to configure a personal computer (PC) card of personal computer memory card international association (PCMCIA), a compact flash (CF) card, a smart media (SM) card, a memory stick, a multimedia card (MMC), a reduced-size multimedia card (RS-MMC), a micro-size version of MMC (MMCmicro), a secure digital (SD) card, a mini secure digital (miniSD) card, a micro secure digital (microSD) card, a secure digital high capacity (SDHC) card, and/or a universal flash storage (UFS).

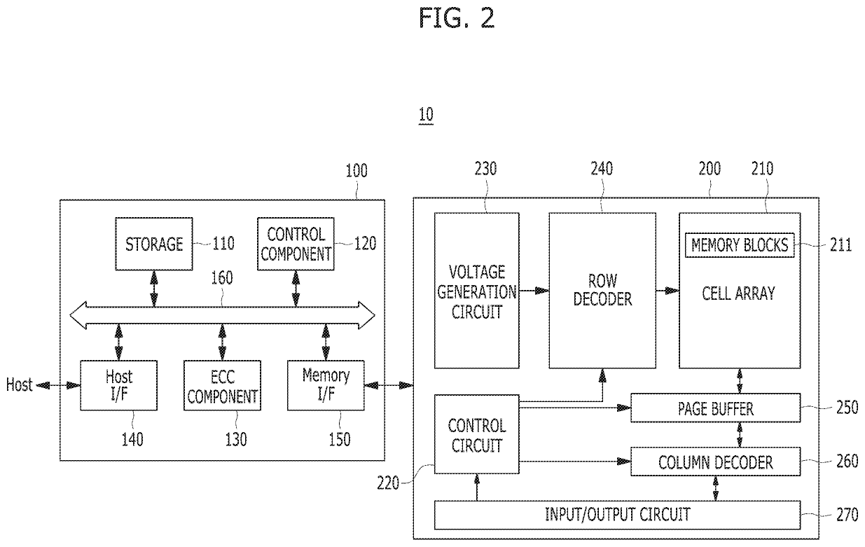

FIG. 2 is a block diagram illustrating a memory system in accordance with an embodiment of the present invention. For example, the memory system of FIG. 2 may depict the memory system 10 shown in FIG. 1.

Referring to FIG. 2, the memory system 10 may include a memory controller 100 and a semiconductor memory device 200. The memory system 10 may operate in response to a request from a host device (e.g., host device 5 of FIG. 1), and in particular, store data to be accessed by the host device.

The memory device 200 may store data may be accessed by the host device.

The memory device 200 may be implemented with a volatile memory device such as a dynamic random access memory (DRAM) and/or a static random access memory (SRAM) or a non-volatile memory device such as a read only memory (ROM), a mask ROM (MROM), a programmable ROM (PROM), an erasable programmable ROM (EPROM), an electrically erasable programmable ROM (EEPROM), a ferroelectric random access memory (FRAM), a phase change RAM (PRAM), a magnetoresistive RAM (MRAM), and/or a resistive RAM (RRAM).

The controller 100 may control storage of data in the memory device 200. For example, the controller 100 may control the memory device 200 in response to a request from the host device. The controller 100 may provide data read from the memory device 200 to the host device, and may store data provided from the host device into the memory device 200.

The controller 100 may include a storage 110, a control component 120, which may be implemented as a processor such as a central processing unit (CPU), an error correction code (ECC) component 130, a host interface (I/F) 140 and a memory interface (I/F) 150, which are coupled through a bus 160.

The storage 110 may serve as a working memory of the memory system 10 and the controller 100, and store data for driving the memory system 10 and the controller 100. When the controller 100 controls operations of the memory device 200, the storage 110 may store data used by the controller 100 and the memory device 200 for such operations as read, write, program and erase operations.

The storage 110 may be implemented with a volatile memory such as a static random access memory (SRAM) or a dynamic random access memory (DRAM). As described above, the storage 110 may store data used by the host device in the memory device 200 for the read and write operations. To store the data, the storage 110 may include a program memory, a data memory, a write buffer, a read buffer, a map buffer, and the like.

The control component 120 may control general operations of the memory system 10, and a write operation or a read operation for the memory device 200, in response to a write request or a read request from the host device. The control component 120 may drive firmware, which is referred to as a flash translation layer (FTL), to control general operations of the memory system 10. For example, the FTL may perform operations such as logical-to-physical (L2P) mapping, wear leveling, garbage collection, and/or bad block handling. The L2P mapping is known as logical block addressing (LBA).

The ECC component 130 may detect and correct errors in the data read from the memory device 200 during the read operation. The ECC component 130 may not correct error bits when the number of the error bits is greater than or equal to a threshold number of correctable error bits, and instead may output an error correction fail signal indicating failure in correcting the error bits.

In various embodiments, the ECC component 130 may perform an error correction operation based on a coded modulation such as a low density parity check (LDDC) code, a Bose-Chaudhuri-Hocquenghem (BCH) code, a turbo code, a turbo product code (TPC), a Reed-Solomon (RS) code, a convolution code, a recursive systematic code (RSC), a trellis-coded modulation (TCM), or a Block coded modulation (BCM). However, error correction is not limited to these techniques. As such, the ECC component 130 may include any and all circuits, systems or devices for suitable error correction operation.

The host interface 140 may communicate with the host device through one or more of various interface protocols such as a universal serial bus (USB), a multi-media card (MMC), a peripheral component interconnect express (PCI-e or PCIe), a small computer system interface (SCSI), a serial-attached SCSI (SAS), a serial advanced technology attachment (SATA), a parallel advanced technology attachment (PATA), an enhanced small disk interface (ESDI), and an integrated drive electronics (IDE).

The memory interface 150 may provide an interface between the controller 100 and the memory device 200 to allow the controller 100 to control the memory device 200 in response to a request from the host device. The memory interface 150 may generate control signals for the memory device 200 and process data under the control of the control component 120. When the memory device 200 is a flash memory such as a NAND flash memory, the memory interface 150 may generate control signals for the memory and process data under the control of the control component 120.

The memory device 200 may include a memory cell array 210, a control circuit 220, a voltage generation circuit 230, a row decoder 240, a page buffer 250, which may be in the form of an array of page buffers, a column decoder 260, and an input and output (input/output) circuit 270. The memory cell array 210 may include a plurality of memory blocks 211 which may store data. The voltage generation circuit 230, the row decoder 240, the page buffer array 250, the column decoder 260 and the input/output circuit 270 may form a peripheral circuit for the memory cell array 210. The peripheral circuit may perform a program, read, or erase operation of the memory cell array 210. The control circuit 220 may control the peripheral circuit.

The voltage generation circuit 230 may generate operation voltages of various levels. For example, in an erase operation, the voltage generation circuit 230 may generate operation voltages of various levels such as an erase voltage and a pass voltage.

The row decoder 240 may be in electrical communication with the voltage generation circuit 230, and the plurality of memory blocks 211. The row decoder 240 may select at least one memory block among the plurality of memory blocks 211 in response to a row address generated by the control circuit 220, and transmit operation voltages supplied from the voltage generation circuit 230 to the selected memory blocks.

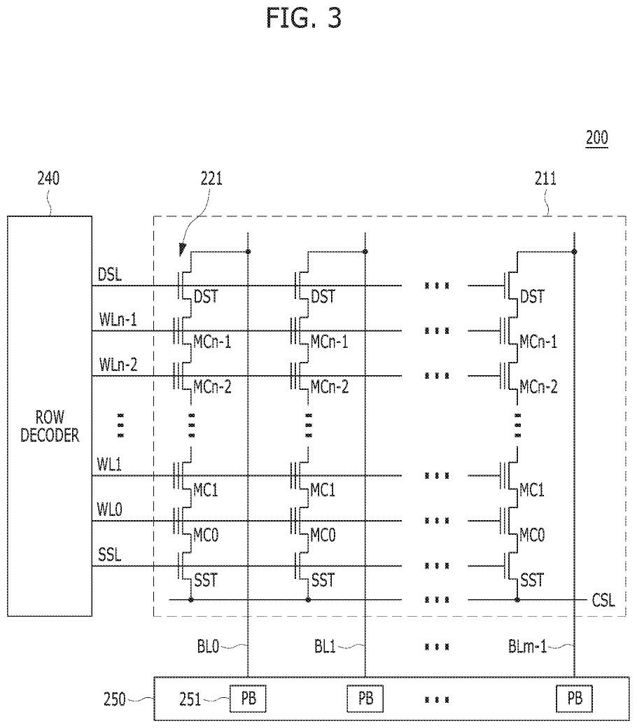

The page buffer 250 may be coupled with the memory cell array 210 through bit lines BL (shown in FIG. 3). The page buffer 250 may precharge the bit lines BL with a positive voltage, transmit data to, and receive data from, a selected memory block in program and read operations, or temporarily store transmitted data, in response to page buffer control signal(s) generated by the control circuit 220.

The column decoder 260 may transmit data to, and receive data from, the page buffer 250 or transmit and receive data to and from the input/output circuit 270.

The input/output circuit 270 may transmit to the control circuit 220 a command and an address, received from an external device (e.g., the memory controller 100 of FIG. 1), transmit data from the external device to the column decoder 260, or output data from the column decoder 260 to the external device, through the input/output circuit 270.

The control circuit 220 may control the peripheral circuit in response to the command and the address.

FIG. 3 is a circuit diagram illustrating a memory block of a semiconductor memory device in accordance with an embodiment of the present invention. For example, the memory block of FIG. 3 may be any of the memory blocks 211 of the memory cell array 210 shown in FIG. 2.

Referring to FIG. 3, the exemplary memory block 211 may include a plurality of word lines WL0 to WLn−1, a drain select line DSL and a source select line SSL coupled to the row decoder 240. These lines may be arranged in parallel, with the plurality of word lines between the DSL and SSL.

The exemplary memory block 211 may further include a plurality of cell strings 221 respectively coupled to bit lines BL0 to BLm−1. The cell string of each column may include one or more drain selection transistors DST and one or more source selection transistors SST. In the illustrated embodiment, each cell string has one DST and one SST. In a cell string, a plurality of memory cells or memory cell transistors MC0 to MCn−1 may be serially coupled between the selection transistors DST and SST. Each of the memory cells may be formed as a multiple level cell. For example, each of the memory cells may be formed as a single level cell (SLC) storing 1 bit of data. Each of the memory cells may be formed as a multi-level cell (MLC) storing 2 bits of data. Each of the memory cells may be formed as a triple-level cell (TLC) storing 3 bits of data. Each of the memory cells may be formed as a quadruple-level cell (QLC) storing 4 bits of data.

The source of the SST in each cell string may be coupled to a common source line CSL, and the drain of each DST may be coupled to the corresponding bit line. Gates of the SSTs in the cell strings may be coupled to the SSL, and gates of the DSTs in the cell strings may be coupled to the DSL. Gates of the memory cells across the cell strings may be coupled to respective word lines. That is, the gates of memory cells MC0 are coupled to corresponding word line WL0, the gates of memory cells MC1 are coupled to corresponding word line WL1, etc. The group of memory cells coupled to a particular word line may be referred to as a physical page. Therefore, the number of physical pages in the memory block 211 may correspond to the number of word lines.

The page buffer array 250 may include a plurality of page buffers 251 that are coupled to the bit lines BL0 to BLm−1. The page buffers 251 may operate in response to page buffer control signals. For example, the page buffers 251 may temporarily store data received through the bit lines BL0 to BLm−1 or sense voltages or currents of the bit lines during a read or verify operation.

In some embodiments, the memory blocks 211 may include a NAND-type flash memory cell. However, the memory blocks 211 are not limited to such cell type, but may include NOR-type flash memory cell(s). Memory cell array 210 may be implemented as a hybrid flash memory in which two or more types of memory cells are combined, or one-NAND flash memory in which a controller is embedded inside a memory chip.

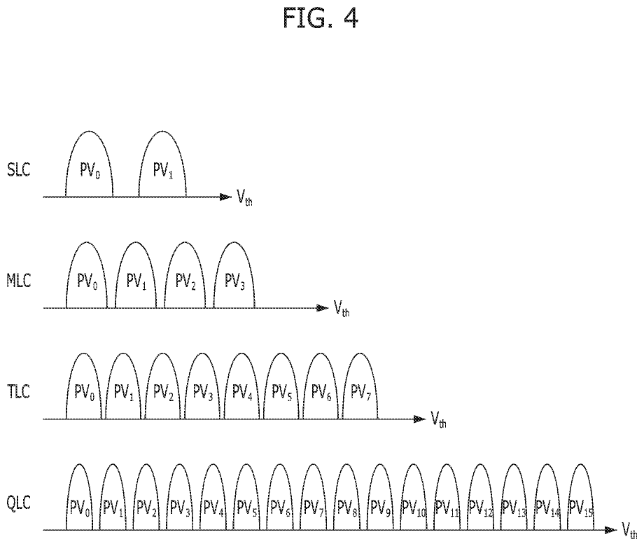

FIG. 4 is a diagram illustrating distributions of states or program voltage (PV) levels for different types of cells of a memory device.

Referring to FIG. 4, each of memory cells may be implemented with a specific type of cell, for example, a single level cell (SLC) storing 1 bit of data, a multi-level cell (MLC) storing 2 bits of data, a triple-level cell (TLC) storing 3 bits of data, or a quadruple-level cell (QLC) storing 4 bits of data. Usually, all memory cells in a particular memory device are of the same type, but that is not a requirement.

An SLC may include two states PV₀ and PV₁. PV₀ may indicate an erase state, and PV₁ may indicate a program state. Since the SLC can be set in one of two different states, each SLC may program or store 1 bit according to a set coding method. An MLC may include four states PV₀, PV₁, PV₂ and PV₃. Among these states, PV₀ may indicate an erase state, and PV₁ to PV₃ may indicate program states. Since the MLC can be set in one of four different states, each MLC may program or store two bits according to a set coding method. A TLC may include eight states PV₀ to PV₇. Among these states, PV₀ may indicate an erase state, and PV₁ to PV₇ may indicate program states. Since the TLC can be set in one of eight different states, each TLC may program or store three bits according to a set coding method. A QLC may include 16 states PV₀ to PV₁₅. Among these states, PV₀ may indicate an erase state, and PV₁ to PV₁₅ may indicate program states. Since the QLC can be set in one of sixteen different states, each QLC may program or store four bits according to a set coding method. For an n-bit multiple level cell flash memory as mentioned above, cells can be modulated into multiple states based on their program voltage levels. SLC, MLC, TLC and QLC memories can store one bit, two bits, three bits and four bits respectively in each cell using 2, 4, 8 and 16 possible states.

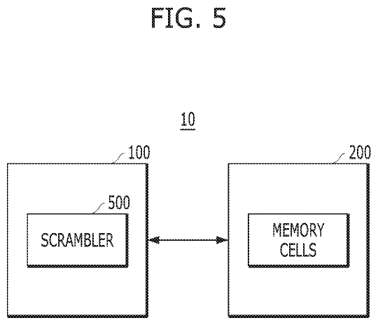

FIG. 5 is a diagram illustrating a memory system 10 in accordance with an embodiment of the present invention.

Referring to FIG. 5, the memory system 10 may include a controller 100 and a memory device 200. The memory device 200 may include a plurality of memory cells (e.g., NAND flash memory cells). The memory cells are arranged in an array of rows and columns as shown in FIG. 3. The cells in each row are connected to a word line (e.g., WL0), while the cells in each column are coupled to a bit line (e.g., BL0). These word and bit lines are used for read and write operations. During a write operation, the data to be written (‘1’ or ‘0’) is provided at the bit line while the word line is asserted. During a read operation, the word line is again asserted, and the threshold voltage of each cell can then be acquired from the bit line. Multiple pages may share the memory cells that are coupled to the same word line. When the memory cells are implemented with MLCs, the multiple pages include a most significant bit (MSB) page and a least significant bit (LSB) page. When the memory cells are implemented with TLCs, the multiple pages include an MSB page, a center significant bit (CSB) page and an LSB page. When the memory cells are implemented with QLCs, the multiple pages include an MSB page, a center most significant bit (CMSB) page, a center least significant bit (CLSB) page and an LSB page. The memory cells may be programmed using a coding scheme (e.g., Gray coding) in order to increase the capacity of the memory system 10 such as SSD.

The controller 100 may include a scrambler 500. Although not shown in FIG. 5, the controller 100 and the memory device 200 may include various other components of the memory system 10 as shown in FIG. 2. The scrambler 500 may receive data from a host device (e.g., a host 5 of FIG. 1) and scramble (or randomize) the data to generate scrambled data. The scrambled data may be programmed in memory cells of the memory device 200. Since programming data “as is” tends to decrease endurance of the memory system 10, the scrambler 500 (or randomizer) uniformly programs data to the memory device 200.

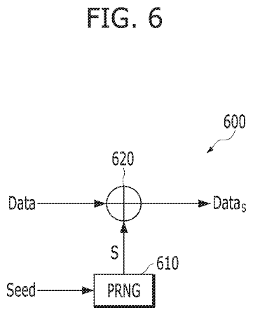

FIG. 6 illustrates a standard scrambler 600.

Referring to FIG. 6, the scrambler 600 may include a pseudorandom number generator (PRNG) 610 and an exclusive OR (XOR) operator 620. The PRNG 610 may generate a pseudorandom number S in response to a seed value based on a logical block address (LBA) or a physical page number (PPN). The XOR operator 620 may perform an XOR operation on data (Data) with the output of the PRNG 610 to generate scrambled data (Data_{S}). The scrambled data (Data_{S}) may be programmed to a memory device.

In FIG. 6, if data (Data) with the same pattern (e.g., systematic data) is received from the host device with the same seed value (i.e., LBA or PPN) multiple times, scrambled data (Data_{S}) with the same data pattern is generated and programmed to the memory device. For example, systematic data (Data) (e.g., firmware (FW) metadata, logical-to-physical (L2P) table, etc.) are converted to scrambled data (Data_{S}) with the same data pattern even after scrambling by the XOR operator 620, which can potentially degrade reliability of the particular page or block. If the memory system has an encryption engine (e.g., advanced encryption standard (AES) engine) with key refreshment, this degradation would not be a problem because data is further processed after randomization (or scrambling). However, if encryption is not implemented (e.g., as in mobile NAND flash devices), programming systematic data patterns decreases reliability of each memory cell and increases bit error rate (BER) for memory cells of the memory device. Accordingly, it is desirable to provide an improved scrambler to avoid the drawback above.

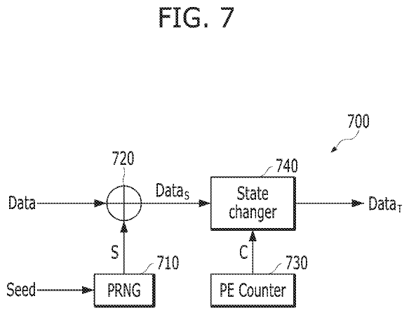

FIG. 7 is a diagram illustrating a scrambler 700 in accordance with embodiments of the present invention.

Referring to FIG. 7, the scrambler 700 may include a PRNG 710, a XOR operator 720, and a program and erase (PE) counter 730. Further, the scrambler 700 may include a state changer 740.

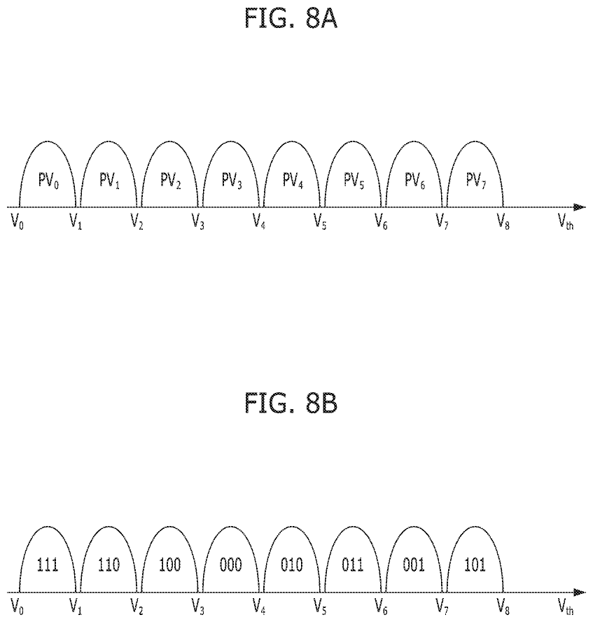

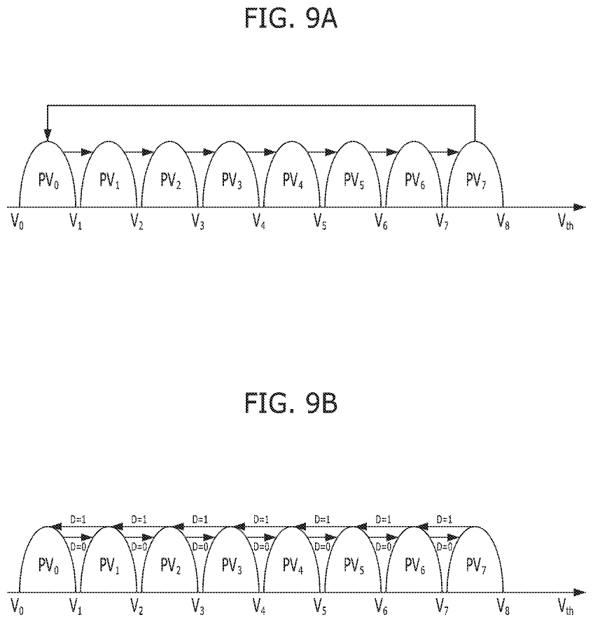

The XOR operator 720 may receive data from a host device (e.g., the host device 5 of FIG. 1). In some embodiments, the data includes firmware metadata or data regarding L2P table. The data is to be programmed (or written) to memory cells of a memory device (e.g., the memory device 200 of FIG. 5). When the memory device 200 is implemented with TLC NAND flash memory device, distribution of threshold voltages for a memory cell of TLC NAND flash memory device is shown in FIG. 8A.

In FIG. 8A, for multiple pages (i.e., MSB, CSB and LSB pages) of TLCs, there are 8 states (or program-verify (PV) levels) PV₀ to PV₇ and 9 threshold voltages V₀ to V₈ to distinguish between two adjacent states. 8 states include an erase state E (or PV₀) and a first program state PV₁ to a seventh program state PV₇. Each PV level characterizes threshold voltage (Vₜₕ) distribution for a particular value of TLC. TLCs may be programmed using an encoding scheme (e.g., Gray coding) as shown in FIG. 8B.

In FIG. 8B, each program-verify level has a set number of bits (i.e., 3 bits for TLC). In accordance with Gray coding, Hamming distance (HD) between the neighboring PV levels (i.e., PVᵢ and PVᵢ₊₁, i=0 . . . 6) should be 1. In the illustrated embodiment, memory cells are programed such that each state has any subset of encoding values among set encoding values for multiple states. For example, the erase state PV₀ corresponds to “111”. The first program state PV₁ may correspond to “110”. The second program state PV₂ may correspond to “100”. The third program state PV₃ may correspond to “000”. The fourth program state PV₄ may correspond to “010”. The fifth program state PV₅ may correspond to “011”. The sixth program state PV© may correspond to “001”. The seventh program state PV₇ may correspond to “101”. Instead of the encoding scheme shown in FIG. 8B, various other encoding schemes may be used.

Referring back to FIG. 7, the PRNG 710 may generate a pseudorandom number S in response to a seed value based on a logical block address (LBA) or a physical page number (PPN). The XOR operator 720 may perform an exclusive OR (XOR) operation on the data (Data) with the pseudorandom number (5) to generate first scrambled data (Data_{S}).

The state changer 740 may identify a state corresponding to the first scrambled data (Data_{S}) from among multiple states in a set threshold voltage distribution (e.g., the threshold voltage distribution of FIG. 8B). For example, when the first scrambled data (Data_{S}) is “111”, the state changer 740 may identify a state PV₀ corresponding to “111” among multiple states PV₀ to PV₇, from the threshold voltage distribution of FIG. 8B. When the first scrambled data (Data_{S}) is “000”, the state changer 740 may identify a state PV₃ corresponding to “000” among the multiple states PV₀ to PV₇. When the first scrambled data (Data_{S}) is “001”, the state changer 740 may identify a state PV₆ corresponding to “001” among the multiple states PV₀ to PV₇.

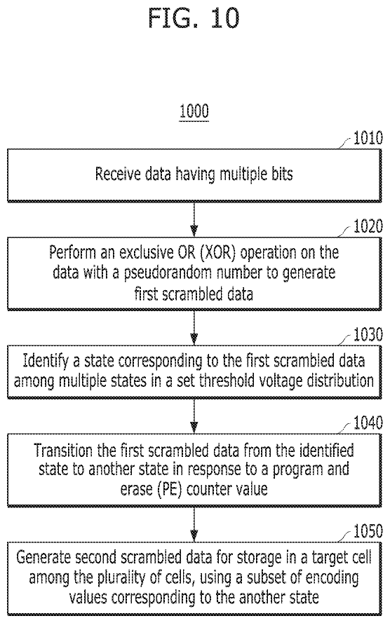

The state changer 740 may transition the first scrambled data (Data_{S}) from the identified state to another state of the multiple states, in response to a program and erase (PE) counter value C. The PE counter value (C) may be generated by the PE counter 730. In some embodiments, for each memory cell, the state changer 740 may transition the first scrambled data (Data_{S}) from identified state to a neighboring state adjacent to the identified state, among the multiple states, in accordance with an algorithm (i.e., Algorithm 1) as shown in FIG. 9A. FIG. 9A illustrates multiple states arranged in ascending order. For Algorithm 1, a target block associated with a target cell for program is erased (step 1) and transition is performed (step 2).

Referring to FIG. 9A, if a current PV is PVᵢ (0≤i≤6), the state changer 740 changes PVᵢ to PVᵢ₊₁. For example, when a current PV is PV₀, the state changer 740 changes PV₀ to PV₁, except that the last PV state is changed to the first PV state. When a current PV is PV₂, the state changer 740 changes PV₂ to PV₃. When a current PV is PV₄, the state changer 740 changes PV₄ to PV₅. When a current PV is PV₆, the state changer 740 changes PV₆ to PV₇. If a current PV is PVᵢ (i=7), the state changer 740 changes PV₇ to PV₀. For this implementation, a transition table as shown in Table1 below may be provided as a combinational logic block in hardware or as an array in firmware (FW).

TABLE 1

| Current State | Neighboring (transition) State |
|---|---|
| PV₀ | PV₁ |
| PV₁ | PV₂ |
| PV₂ | PV₃ |
| PV₃ | PV₄ |
| PV₄ | PV₅ |
| PV₅ | PV₆ |
| PV₆ | PV₇ |
| PV₇ | PV₀ |

In other embodiments, for each memory cell, the state changer 740 may transition the first scrambled data (Data_{S}) from the identified state to the neighboring state in accordance with an algorithm (i.e., Algorithm 2) as shown in FIG. 9B. FIG. 9B illustrates multiple states arranged in ascending order and descending order. For Algorithm 2, a target block associated with a target cell for program is erased (step 1) and transition is performed (step 2). Two directions of transition are performed based on a set variable D.

Referring to FIG. 9B, there are two directions of transition, i.e., D=0 or D=1. For D=0, if a current PV is PVᵢ (0≤i≤6), the state changer 740 changes PVᵢ to PVᵢ₊₁. For example, when a current PV is PV₀, the state changer 740 changes PV₀ to PV₁. When a current PV is PV₂, the state changer 740 changes PV₂ to PV₃. When a current PV is PV₄, the state changer 740 changes PV₄ to PV₅. When a current PV is PV₆, the state changer 740 changes PV₆ to PV₇. For D=0, if a current PV is PVᵢ (i=7), the state changer 740 changes PV₇ to PV₆ and set D=1. For D=1, if a current PV is PVᵢ (1≤i≤7), the state changer 740 changes PVᵢ to PVᵢ₋₁. For example, when a current PV is PV₇, the state changer 740 changes PV₇ to PV₆. When a current PV is PV₅, the state changer 740 changes PV₅ to PV₄. When a current PV is PV₃, the state changer 740 changes PV₃ to PV₂. When a current PV is PV₁, the state changer 740 changes PV₁ to PV₀. For D=1, if a current PV is PVᵢ (i=0), the state changer 740 changes PV₀ to PV₁ and set D=0. For this implementation, a transition table as shown in Tablet below may be provided as a combinational logic block in hardware of the controller 100 or as an array in firmware (FW) of the controller 100. Algorithm 2 is similar to Algorithm 1, but requires additional space to store variable D. However, it does not reset PV₇ value to PV₀, which improves the endurance.

TABLE 2

| Current | Previous | Current | Neighboring |
|---|---|---|---|
| State | Direction | Direction | (transition) State |
| PV₀ | D = 0 | D = 0 | PV₁ |
| PV₁ | D = 0 | D = 0 | PV₂ |
| PV₂ | D = 0 | D = 0 | PV₃ |
| PV₃ | D = 0 | D = 0 | PV₄ |
| PV₄ | D = 0 | D = 0 | PV₅ |
| PV₅ | D = 0 | D = 0 | PV₆ |
| PV₆ | D = 0 | D = 0 | PV₇ |
| PV₇ | D = 0 | D = 1 | PV₆ |
| PV₆ | D = 1 | D = 1 | PV₅ |
| PV₅ | D = 1 | D = 1 | PV₄ |
| PV₄ | D = 1 | D = 1 | PV₃ |
| PV₃ | D = 1 | D = 1 | PV₂ |
| PV₂ | D = 1 | D = 1 | PV₁ |
| PV₁ | D = 1 | D = 1 | PV₀ |
| PV₀ | D = 1 | D = 0 | PV₁ |

Referring back to FIG. 7, the state changer 740 may identify a subset of encoding values (e.g., “110”) corresponding to the neighboring state, among set encoding values for the multiple states (e.g., encoding values in FIG. 8B), For example, when the neighboring state is PV₁, the state changer 740 may identify a subset of encoding values “110” corresponding to PV₁. When the neighboring state is PV₃, the state changer 740 may identify a subset of encoding values “000” corresponding to PV₃. When the neighboring state is PV₅, the state changer 740 may identify a subset of encoding values “011” corresponding to PV₅. When the neighboring state is PV₇, the state changer 740 may identify a subset of encoding values “101” corresponding to PV₇. The state changer 740 may generate second scrambled data (Data_{T}) including the identified subset of encoding values corresponding to the neighboring state.

As described above, the scrambler 700 generates scrambled data through data XOR operation. Further, through being aware of the encoding scheme, after each PE cycle, the scrambler 700 changes the scrambled data, i.e., changes the current PV value to another PV value (e.g., the neighboring PV value) to generate second scrambled data corresponding to the another PV value (e.g., the neighboring PV value). The scrambler 700 provides better endurance than the scrambler 600 since it is designed specifically for PV encoding scheme. By way example and without any limitation, FIGS. 7 to 9B illustrate the scrambler 700 for TLC memory device. However, the scrambler 700 may be applied to MLC, QLC or other types of NAND flash devices consistent with the teachings herein.

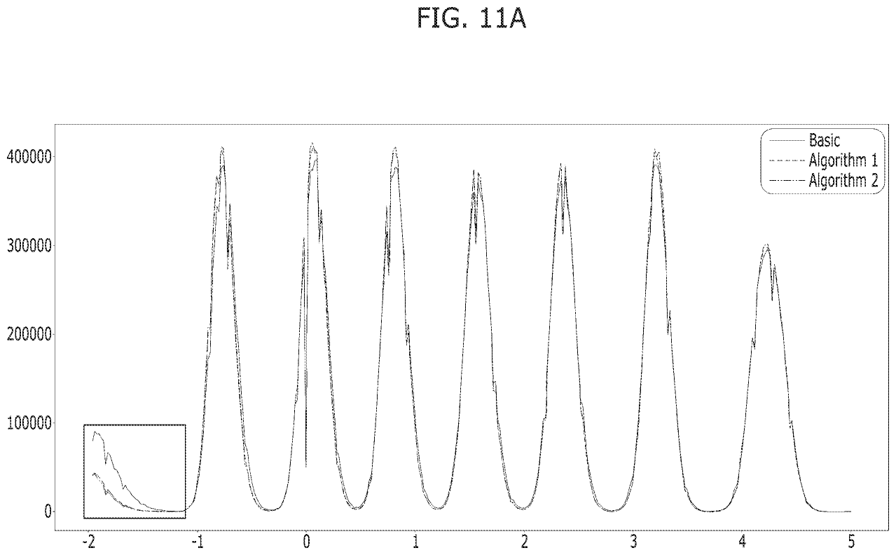

FIG. 10 is a flowchart illustrating an operation 1000 of the scrambler 700 in accordance with an embodiment of the present invention. The operation 1000 may be performed by components 710, 720, 730 and 740 of the scrambler 700 in FIG. 7.

Referring to FIG. 10, the operation 1000 may include steps 1010 to 1050. The operation 1000 may be performed on the plurality of cells of the memory device 200 in FIG. 5. At step 1010, the scrambler 700 may receive data having multiple bits, a set number of bits depending on the type of memory cells employed. At step 1020, the scrambler 700 may perform an exclusive OR (XOR) operation on the data with a pseudorandom number to generate first scrambled data. In some embodiments, the pseudorandom number is generated in response to a seed value based on a logical block address (LBA) or a physical page number (PPN).

At step 1030, the scrambler 700 may identify a state corresponding to the first scrambled data, among multiple states in a set threshold voltage distribution. At step 1040, the scrambler 700 may transition the first scrambled data from the identified state to another state of the multiple states in response to a program and erase (PE) counter value. In some embodiments, the another state includes a neighboring state adjacent to the identified state, among the multiple states. At step 1050, the scrambler 700 may generate second scrambled data for storage in a target cell among the plurality of cells, using a subset of encoding values corresponding to the another state, among set encoding values for the multiple states.

The present inventors observed that the scrambler 700 provides better endurance (or reliablity) than the scrambler 600. To check the endurance of the memory system, three approaches of the scramblers 600, 700 shown in FIGS. 6 and 7 have been tested as steps in the following List1:

List 1

(Step 1) Generate random data pattern for a block.
(Step 2) Perform 3000 PE cycles using generated data.
(Step 3) Heat the memory system to 85° C. for 6 hours.
(Step 4) Check threshold voltages distribution for the block.
(Step 5) Analyze PV₀ (“111”) region.

In List1, at step 1, random data pattern for a block is generated. At step 2, 3000 PE cycles using generated data are performed. At step 3, the memory system is heated to 85° C. for 6 hours. At step 4, threshold voltages distribution for the block is checked. At step 5, PV₀ (“111”) region is analyzed.

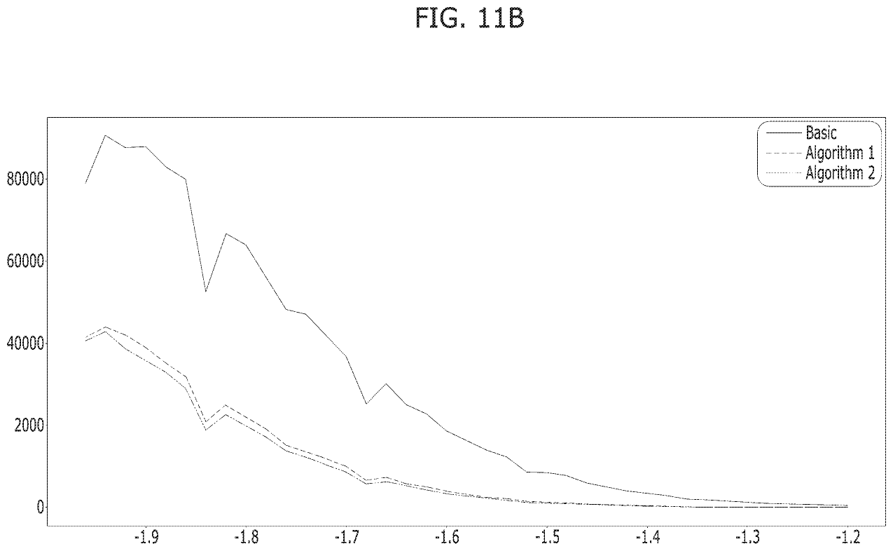

Test results are shown in FIGS. 11A and 11B. In FIGS. 11A and 11B, x-axis represents threshold voltages, y-axis represents probability density of threshold voltages, “Basic” corresponds to the scrambler 600, “Algorithm 1” corresponds to a first approach (i.e., FIG. 9A) of the scrambler 700, and “Algorithm 2” corresponds to a second approach (i.e., FIG. 9B) of the scrambler 700. FIG. 11A illustrates threshold voltage distribution for all PV regions (or levels), and FIG. 11B illustrates threshold voltage distribution for PV₀ region. As well-known in this art, threshold voltages distribution in PV₀ region influences bit error rate (BER) of the NAND storage, and smaller frequency of the values in the region provides better reliability. Referring to FIG. 11B, “Algorithm 2” indicates best reliability, and “Algorithm 1” indicates better reliability than “Basic.” Algorithms 1, 2 have shown a better result than the basic technique. Algorithm 1 requires less hardware or software overhead for its implementation but is worse than Algorithm 2 in terms of reliability (or endurance).

As described above, embodiments provide a data scrambler capable of enhancing the reliability of the memory system for data.

Although the foregoing embodiments have been illustrated and described in some detail for purposes of clarity and understanding, the present invention is not limited to the details provided. There are many alternative ways of implementing the invention, as one skilled in the art will appreciate in light of the foregoing disclosure. The disclosed embodiments are thus illustrative, not restrictive. The present invention is intended to embrace all modifications and alternatives that fall within the scope of the claims.

What is claimed is:

1. A memory system comprising:
a memory device including a plurality of cells; and
a controller including a scrambler, which is coupled to the memory device and suitable for:
receiving data having multiple bits;
performing an exclusive OR (XOR) operation on the data with a pseudorandom number to generate first scrambled data, the pseudorandom number being generated in response to a seed value based on a logical block address (LBA) or a physical page number (PPN);
identifying a state corresponding to the first scrambled data, among multiple states in a set threshold voltage distribution;
transitioning the first scrambled data from the identified state to another state of the multiple states in response to a program and erase (PE) counter value; and
generating second scrambled data for storage in a target cell among the plurality of cells, using a subset of encoding values corresponding to the another state, among set encoding values for the multiple states.

2. The memory system of claim 1, wherein the plurality of cells includes a group of triple-level cells (TLCs), which are coupled to a single word line and include a most significant bit (MSB) page, a center significant bit (CSB) page and a least significant bit (LSB) page.

3. The memory system of claim 1, wherein the multiple states include an erase state and first program state to last program state in ascending order.

4. The memory system of claim 3, wherein the another state includes a neighboring state adjacent to the identified state.

5. The memory system of claim 4, wherein the identified state and the neighboring state are arranged in ascending order.

6. The memory system of claim 5, wherein,
when the identified state is the last program state, the neighboring state is the erase state.

7. The memory system of claim 5, wherein, when the identified state is the last program state, the neighboring state is a state before the last program state.

8. The memory system of claim 4, wherein the identified state and the neighboring state are arranged in descending order.

9. The memory system of claim 8, wherein, when the identified state is the erase state, the neighboring state is the first program state.

10. A method for operating a memory system, which includes a memory device including a plurality of cells and a controller including a scrambler coupled to the memory device, the method comprising:
receiving data having multiple bits;
performing an exclusive OR (XOR) operation on the data with a pseudorandom number to generate first scrambled data, the pseudorandom number being generated in response to a seed value based on a logical block address (LBA) or a physical page number (PPN);
identifying a state corresponding to the first scrambled data, among multiple states in a set threshold voltage distribution;
transitioning the first scrambled data from the identified state to another state of the multiple states in response to a program and erase (PE) counter value; and
generating second scrambled data for storage in a target cell among the plurality of cells, using a subset of encoding values corresponding to the another state, among set encoding values for the multiple states.

11. The method of claim 10, wherein each of the plurality of cells includes triple-level cells (TLCs), which are coupled to a single word line and include a most significant bit (MSB) page, a center significant bit (CSB) page and a least significant bit (LSB) page.

12. The method of claim 10, wherein the multiple states include an erase state and first program state to last program state in ascending order.

13. The method of claim 12, wherein the another state includes a neighboring state adjacent to the identified state.

14. The method of claim 13, wherein the identified state and the neighboring state are arranged in ascending order.

15. The method of claim 14, wherein,
when the identified state is the last program state, the neighboring state is the erase state.

16. The method of claim 14, wherein, when the identified state is the last program state, the neighboring state is a state before the last program state.

17. The method of claim 13, wherein the identified state and the neighboring state are arranged in descending order.

18. The method of claim 17, wherein, when the identified state is the erase state, the neighboring state is the first program state.
